(19) United States
(12) Patent Application Publication
(10) Pub. No.: US 2021/0021293 A1
(43) Pub. Date: Jan. 21, 2021

(54) CABLE TELEVISION APPARATUS WITH COMPENSATION ANTENNA

(71) Applicant: CABLE VISION ELECTRONICS CO., LTD, New Taipei City (TW)

(72) Inventors: I-Sheng TING, New Taipei City (TW); Chiang-Po YANG, New Taipei City (TW)

(21) Appl. No.: 16/600,535

(22) Filed: Oct. 13, 2019

(30) Foreign Application Priority Data
Jul. 15, 2019 (TW) 108209198

(51) Int. Cl. H04B 1/18; H04N 5/44

(52) U.S. Cl. CPC H04B 1/18; H04N 5/44

(57) ABSTRACT

A cable television apparatus is applied to an input coaxial cable and an output coaxial cable. The input coaxial cable and the output coaxial cable transmit a cable television signal. The cable television apparatus includes an input side, an output side, a directional coupler and a compensation antenna. The directional coupler includes a coupler input side, a coupler output side, a coupler matching side and a coupler coupling side. The compensation antenna is electrically connected to the coupler matching side of the directional coupler or the coupler coupling side of the directional coupler. The directional coupler utilizes the compensation antenna to wirelessly send out a coupler signal or receive a high frequency wireless cable television signal to proceed a signal compensation.

### BACKGROUND OF THE INVENTION

### Field of the Invention

The present invention relates to a cable television apparatus, and especially relates to a cable television apparatus with a compensation antenna.

### Description of the Related Art

Currently, the cable television system is very popular. The cable television system transmits television programs and network signals to client sides through coaxial cables.

The related art cable television system needs to use the related art directional coupler. Usually, characteristics (for examples, the insertion loss or the coupler loss) of the related art directional coupler are worse above the frequency 1.5 GHz.

### SUMMARY OF THE INVENTION

In order to solve the above-mentioned problems, an object of the present invention is to provide a cable television apparatus with a compensation antenna.

In order to achieve the object of the present invention mentioned above, the cable television apparatus of the present invention is applied to an input coaxial cable and an output coaxial cable. The input coaxial cable and the output coaxial cable transmit a cable television signal. The cable television apparatus comprises an input side, an output side, a directional coupler and the compensation antenna. The input side is electrically connected to the input coaxial cable. The output side is electrically connected to the output coaxial cable. The directional coupler is electrically connected to the input side, the input coaxial cable, the output side and the output coaxial cable. The compensation antenna is electrically connected to the directional coupler. Moreover, the directional coupler comprises a coupler input side, a coupler output side, a coupler matching side and a coupler coupling side. The coupler input side is electrically connected to the input side and the input coaxial cable. The coupler output side is electrically connected to the output side and the output coaxial cable. Moreover, the compensation antenna is electrically connected to the coupler matching side of the directional coupler or the coupler coupling side of the directional coupler. The directional coupler is configured to utilize the compensation antenna to wirelessly send out a coupler signal or receive a high frequency wireless cable television signal to proceed a signal compensation.

Moreover, in an embodiment of the cable television apparatus of the present invention mentioned above, the compensation antenna is a metal wire.

Moreover, in an embodiment of the cable television apparatus of the present invention mentioned above, the metal wire is a copper wire.

Moreover, in an embodiment of the cable television apparatus of the present invention mentioned above, the compensation antenna is an adjustable antenna.

Moreover, in an embodiment of the cable television apparatus of the present invention mentioned above, the directional coupler is configured to send the coupler signal to the compensation antenna. After the compensation antenna receives the coupler signal, the compensation antenna is configured to wirelessly send out the coupler signal to proceed the signal compensation.

Moreover, in an embodiment of the cable television apparatus of the present invention mentioned above, the cable television signal is radiated to generate the high frequency wireless cable television signal. The compensation antenna is configured to receive the high frequency wireless cable television signal. After the compensation antenna receives the high frequency wireless cable television signal, the compensation antenna is configured to send the high frequency wireless cable television signal to the directional coupler to proceed the signal compensation.

Moreover, in an embodiment of the cable television apparatus of the present invention mentioned above, the cable television apparatus further comprises a choke. One side of the choke is electrically connected to the input side and the input coaxial cable. The other side of the choke is electrically connected to the output side and the output coaxial cable.

Moreover, in an embodiment of the cable television apparatus of the present invention mentioned above, the cable television apparatus further comprises an input capacitor and an output capacitor. One side of the input capacitor is electrically connected to the input side, the input coaxial cable and one side of the choke. The other side of the input capacitor is electrically connected to the coupler input side of the directional coupler. One side of the output capacitor is electrically connected to the output side, the output coaxial cable and the other side of the choke. The other side of the output capacitor is electrically connected to the coupler output side of the directional coupler.

Moreover, in an embodiment of the cable television apparatus of the present invention mentioned above, the cable television apparatus further comprises a transformer electrically connected to the coupler coupling side of the directional coupler.

Moreover, in an embodiment of the cable television apparatus of the present invention mentioned above, the cable television apparatus further comprises a distribution circuit electrically connected to the transformer.

The advantage of the present invention is to improve the characteristics (for examples, the insertion loss and the coupler loss) of the directional coupler of the cable television system above the frequency 1.5 GHz.

Please refer to the detailed descriptions and figures of the present invention mentioned below for further understanding the technology, method and effect of the present invention achieving the predetermined purposes. It believes that the purposes, characteristic and features of the present invention can be understood deeply and specifically. However, the figures are only for references and descriptions, but the present invention is not limited by the figures.

### BRIEF DESCRIPTION OF DRAWING

FIG. 1 shows the first embodiment of the cable television apparatus of the present invention.

FIG. 2 shows the second embodiment of the cable television apparatus of the present invention.

FIG. 3 shows the third embodiment of the cable television apparatus of the present invention.

FIG. 4 shows the fourth embodiment of the cable television apparatus of the present invention.

FIG. 5 shows the fifth embodiment of the cable television apparatus of the present invention.

FIG. 6 shows the sixth embodiment of the cable television apparatus of the present invention.

FIG. 7 shows the seventh embodiment of the cable television apparatus of the present invention.

FIG. 8 shows the eighth embodiment of the cable television apparatus of the present invention.

### DETAILED DESCRIPTION OF THE INVENTION

In the present disclosure, numerous specific details are provided, to provide a thorough understanding of embodiments of the invention. Persons of ordinary skill in the art will recognize, however, that the present invention can be practiced without one or more of the specific details. In other instances, well-known details are not shown or described to avoid obscuring aspects of the present invention. Now please refer to the figures for the explanation of the technical content and the detailed description of the present invention:

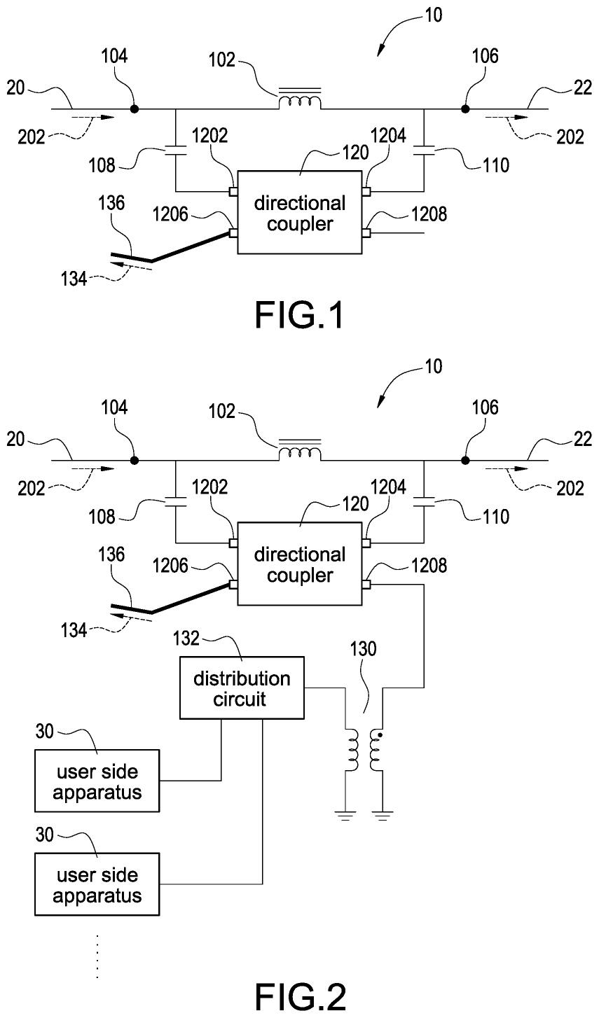

FIG. 1 shows the first embodiment of the cable television apparatus of the present invention. A cable television apparatus 10 of the present invention is applied to an input coaxial cable 20 and an output coaxial cable 22. The input coaxial cable 20 and the output coaxial cable 22 transmit a cable television signal 202. The cable television apparatus 10 comprises an input side 104, an output side 106, a directional coupler 120, a compensation antenna 136, a choke 102, an input capacitor 108 and an output capacitor 110. The directional coupler 120 comprises a coupler input side 1202, a coupler output side 1204, a coupler matching side 1206 and a coupler coupling side 1208. The components mentioned above are electrically connected to each other. The compensation antenna 136 is an adjustable antenna or a metal wire, for example, a copper wire. The directional coupler 120 is configured to utilize the compensation antenna 136 to wirelessly send out a coupler signal 134 to proceed a signal compensation to improve an insertion loss or a coupler loss of the directional coupler 120 above a frequency 1.5 GHz. The directional coupler 120 is configured to send the coupler signal 134 to the compensation antenna 136. After the compensation antenna 136 receives the coupler signal 134, the compensation antenna 136 is configured to wirelessly send out the coupler signal 134 to proceed the signal compensation. The compensation antenna 136 is connected to the coupler matching side 1206 of the directional coupler 120.

FIG. 2 shows the second embodiment of the cable television apparatus of the present invention. A cable television apparatus 10 of the present invention is applied to an input coaxial cable 20, an output coaxial cable 22 and a plurality of user side apparatuses 30. The input coaxial cable 20 and the output coaxial cable 22 transmit a cable television signal 202. The cable television apparatus 10 comprises an input side 104, an output side 106, a directional coupler 120, a compensation antenna 136, a choke 102, an input capacitor 108, an output capacitor 110, a transformer 130 and a distribution circuit 132. The directional coupler 120 comprises a coupler input side 1202, a coupler output side 1204, a coupler matching side 1206 and a coupler coupling side 1208. The components mentioned above are electrically connected to each other. The compensation antenna 136 is an adjustable antenna or a metal wire, for example, a copper wire. The directional coupler 120 is configured to utilize the compensation antenna 136 to wirelessly send out a coupler signal 134 to proceed a signal compensation to improve an insertion loss or a coupler loss of the directional coupler 120 above a frequency 1.5 GHz. The directional coupler 120 is configured to send the coupler signal 134 to the compensation antenna 136. After the compensation antenna 136 receives the coupler signal 134, the compensation antenna 136 is configured to wirelessly send out the coupler signal 134 to proceed the signal compensation. The compensation antenna 136 is connected to the coupler matching side 1206 of the directional coupler 120.

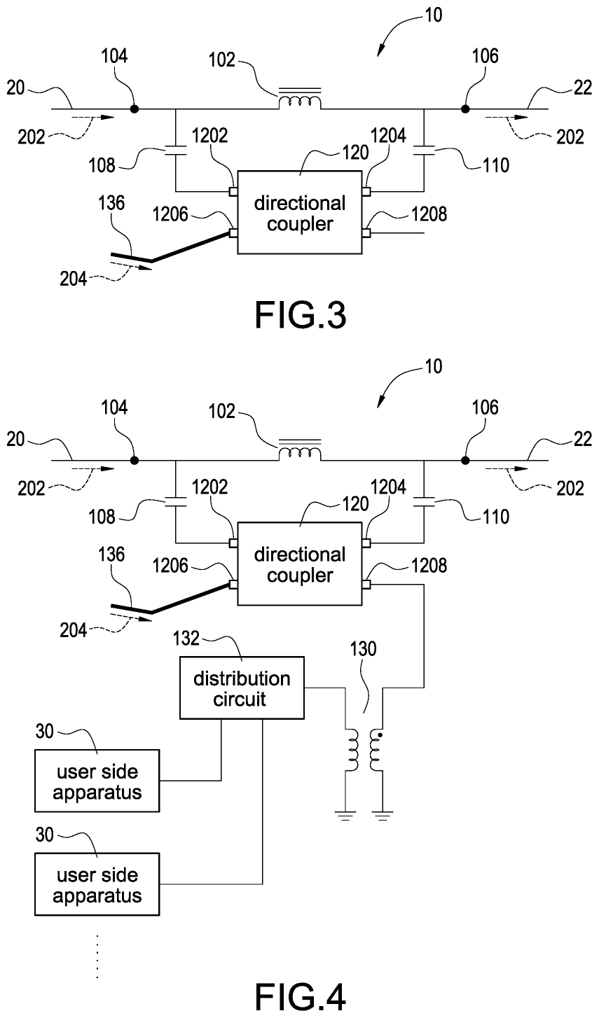

FIG. 3 shows the third embodiment of the cable television apparatus of the present invention. A cable television apparatus 10 of the present invention is applied to an input coaxial cable 20 and an output coaxial cable 22. The input coaxial cable 20 and the output coaxial cable 22 transmit a cable television signal 202. The cable television apparatus 10 comprises an input side 104, an output side 106, a directional coupler 120, a compensation antenna 136, a choke 102, an input capacitor 108 and an output capacitor 110. The directional coupler 120 comprises a coupler input side 1202, a coupler output side 1204, a coupler matching side 1206 and a coupler coupling side 1208. The components mentioned above are electrically connected to each other. The compensation antenna 136 is an adjustable antenna or a metal wire, for example, a copper wire. The directional coupler 120 is configured to utilize the compensation antenna 136 to wirelessly receive a high frequency wireless cable television signal 204 to proceed a signal compensation to improve an insertion loss or a coupler loss of the directional coupler 120 above a frequency 1.5 GHz. The cable television signal 202 is radiated to generate the high frequency wireless cable television signal 204. The compensation antenna 136 is configured to receive the high frequency wireless cable television signal 204. After the compensation antenna 136 receives the high frequency wireless cable television signal 204, the compensation antenna 136 is configured to send the high frequency wireless cable television signal 204 to the directional coupler 120 to proceed the signal compensation. The compensation antenna 136 is connected to the coupler matching side 1206 of the directional coupler 120.

FIG. 4 shows the fourth embodiment of the cable television apparatus of the present invention. A cable television apparatus 10 of the present invention is applied to an input coaxial cable 20, an output coaxial cable 22 and a plurality of user side apparatuses 30. The input coaxial cable 20 and the output coaxial cable 22 transmit a cable television signal 202. The cable television apparatus 10 comprises an input side 104, an output side 106, a directional coupler 120, a compensation antenna 136, a choke 102, an input capacitor 108, an output capacitor 110, a transformer 130 and a distribution circuit 132. The directional coupler 120 comprises a coupler input side 1202, a coupler output side 1204, a coupler matching side 1206 and a coupler coupling side 1208. The components mentioned above are electrically connected to each other. The compensation antenna 136 is an adjustable antenna or a metal wire, for example, a copper wire. The directional coupler 120 is configured to utilize the compensation antenna 136 to wirelessly receive a high frequency wireless cable television signal 204 to proceed a signal compensation to improve an insertion loss or a coupler loss of the directional coupler 120 above a frequency 1.5 GHz. The cable television signal 202 is radiated to generate the high frequency wireless cable television signal 204. The compensation antenna 136 is configured to receive the high frequency wireless cable television signal 204. After the compensation antenna 136 receives the high frequency wireless cable television signal 204, the compensation antenna 136 is configured to send the high frequency wireless cable television signal 204 to the directional coupler 120 to proceed the signal compensation. The compensation antenna 136 is connected to the coupler matching side 1206 of the directional coupler 120.

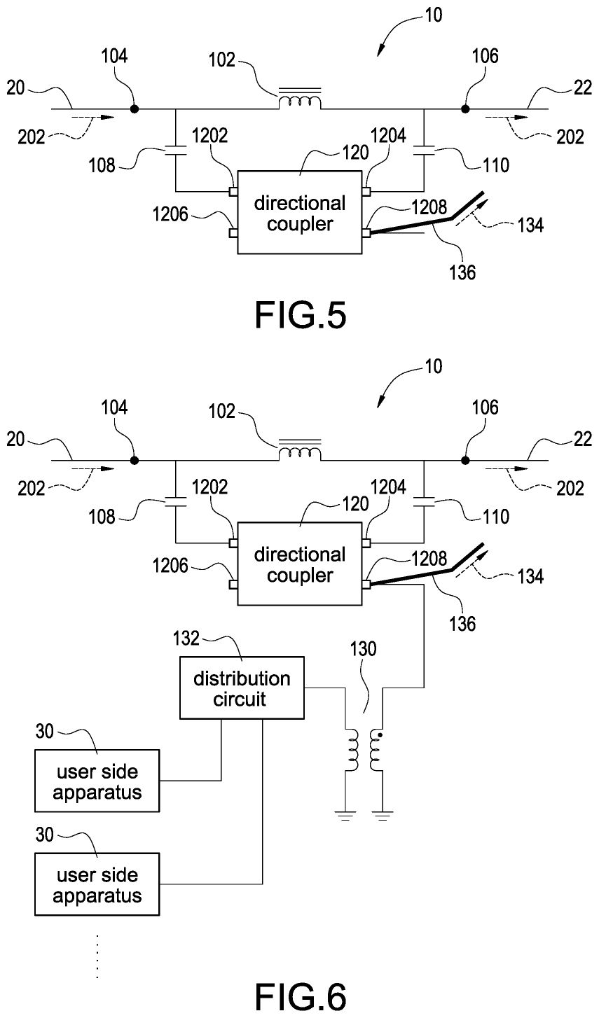

FIG. 5 shows the fifth embodiment of the cable television apparatus of the present invention. A cable television apparatus 10 of the present invention is applied to an input coaxial cable 20 and an output coaxial cable 22. The input coaxial cable 20 and the output coaxial cable 22 transmit a cable television signal 202. The cable television apparatus 10 comprises an input side 104, an output side 106, a directional coupler 120, a compensation antenna 136, a choke 102, an input capacitor 108 and an output capacitor 110. The directional coupler 120 comprises a coupler input side 1202, a coupler output side 1204, a coupler matching side 1206 and a coupler coupling side 1208. The components mentioned above are electrically connected to each other. The compensation antenna 136 is an adjustable antenna or a metal wire, for example, a copper wire. The directional coupler 120 is configured to utilize the compensation antenna 136 to wirelessly send out a coupler signal 134 to proceed a signal compensation to improve an insertion loss of the directional coupler 120 above a frequency 1.5 GHz. The directional coupler 120 is configured to send the coupler signal 134 to the compensation antenna 136. After the compensation antenna 136 receives the coupler signal 134, the compensation antenna 136 is configured to wirelessly send out the coupler signal 134 to proceed the signal compensation. The compensation antenna 136 is connected to the coupler coupling side 1208 of the directional coupler 120.

FIG. 6 shows the sixth embodiment of the cable television apparatus of the present invention. A cable television apparatus 10 of the present invention is applied to an input coaxial cable 20, an output coaxial cable 22 and a plurality of user side apparatuses 30. The input coaxial cable 20 and the output coaxial cable 22 transmit a cable television signal 202. The cable television apparatus 10 comprises an input side 104, an output side 106, a directional coupler 120, a compensation antenna 136, a choke 102, an input capacitor 108, an output capacitor 110, a transformer 130 and a distribution circuit 132. The directional coupler 120 comprises a coupler input side 1202, a coupler output side 1204, a coupler matching side 1206 and a coupler coupling side 1208. The components mentioned above are electrically connected to each other. The compensation antenna 136 is an adjustable antenna or a metal wire, for example, a copper wire. The directional coupler 120 is configured to utilize the compensation antenna 136 to wirelessly send out a coupler signal 134 to proceed a signal compensation to improve an insertion loss of the directional coupler 120 above a frequency 1.5 GHz. The directional coupler 120 is configured to send the coupler signal 134 to the compensation antenna 136. After the compensation antenna 136 receives the coupler signal 134, the compensation antenna 136 is configured to wirelessly send out the coupler signal 134 to proceed the signal compensation. The compensation antenna 136 is connected to the coupler coupling side 1208 of the directional coupler 120.

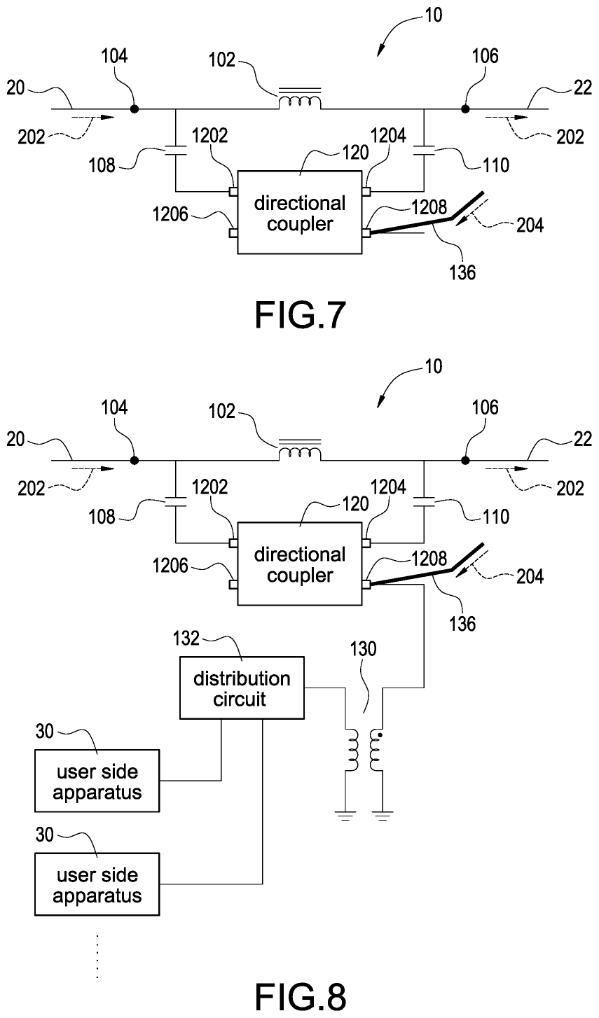

FIG. 7 shows the seventh embodiment of the cable television apparatus of the present invention. A cable television apparatus 10 of the present invention is applied to an input coaxial cable 20 and an output coaxial cable 22. The input coaxial cable 20 and the output coaxial cable 22 transmit a cable television signal 202. The cable television apparatus 10 comprises an input side 104, an output side 106, a directional coupler 120, a compensation antenna 136, a choke 102, an input capacitor 108 and an output capacitor 110. The directional coupler 120 comprises a coupler input side 1202, a coupler output side 1204, a coupler matching side 1206 and a coupler coupling side 1208. The components mentioned above are electrically connected to each other.

The compensation antenna 136 is an adjustable antenna or a metal wire, for example, a copper wire. The directional coupler 120 is configured to utilize the compensation antenna 136 to wirelessly receive a high frequency wireless cable television signal 204 to proceed a signal compensation to improve a coupler loss of the directional coupler 120 above a frequency 1.5 GHz. The cable television signal 202 is radiated to generate the high frequency wireless cable television signal 204. The compensation antenna 136 is configured to receive the high frequency wireless cable television signal 204. After the compensation antenna 136 receives the high frequency wireless cable television signal 204, the compensation antenna 136 is configured to send the high frequency wireless cable television signal 204 to the directional coupler 120 to proceed the signal compensation. The compensation antenna 136 is connected to the coupler coupling side 1208 of the directional coupler 120.

FIG. 8 shows the eighth embodiment of the cable television apparatus of the present invention. A cable television apparatus 10 of the present invention is applied to an input coaxial cable 20, an output coaxial cable 22 and a plurality of user side apparatuses 30. The input coaxial cable 20 and the output coaxial cable 22 transmit a cable television signal 202. The cable television apparatus 10 comprises an input side 104, an output side 106, a directional coupler 120, a compensation antenna 136, a choke 102, an input capacitor 108, an output capacitor 110, a transformer 130 and a distribution circuit 132. The directional coupler 120 comprises a coupler input side 1202, a coupler output side 1204, a coupler matching side 1206 and a coupler coupling side 1208. The components mentioned above are electrically connected to each other. The compensation antenna 136 is an adjustable antenna or a metal wire, for example, a copper wire. The directional coupler 120 is configured to utilize the compensation antenna 136 to wirelessly receive a high frequency wireless cable television signal 204 to proceed a signal compensation to improve a coupler loss of the directional coupler 120 above a frequency 1.5 GHz. The cable television signal 202 is radiated to generate the high frequency wireless cable television signal 204. The compensation antenna 136 is configured to receive the high frequency wireless cable television signal 204. After the compensation antenna 136 receives the high frequency wireless cable television signal 204, the compensation antenna 136 is configured to send the high frequency wireless cable television signal 204 to the directional coupler 120 to proceed the signal compensation. The compensation antenna 136 is connected to the coupler coupling side 1208 of the directional coupler 120.

The advantage of the present invention is to improve the characteristics (for examples, the insertion loss and the coupler loss) of the directional coupler of the cable television system above the frequency 1.5 GHz.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A cable television apparatus applied to an input coaxial cable and an output coaxial cable, the input coaxial cable and the output coaxial cable transmitting a cable television signal, the cable television apparatus comprising:
an input side electrically connected to the input coaxial cable;
an output side electrically connected to the output coaxial cable;
a directional coupler electrically connected to the input side, the input coaxial cable, the output side and the output coaxial cable; and
a compensation antenna electrically connected to the directional coupler,
wherein the directional coupler comprises:
a coupler input side electrically connected to the input side and the input coaxial cable;
a coupler output side electrically connected to the output side and the output coaxial cable;
a coupler matching side; and
a coupler coupling side,
wherein the compensation antenna is electrically connected to the coupler matching side of the directional coupler or the coupler coupling side of the directional coupler; the directional coupler is configured to utilize the compensation antenna to wirelessly send out a coupler signal or receive a high frequency wireless cable television signal to proceed a signal compensation.

2. The cable television apparatus in claim 1, wherein the compensation antenna is a metal wire.

3. The cable television apparatus in claim 2, wherein the metal wire is a copper wire.

4. The cable television apparatus in claim 1, wherein the compensation antenna is an adjustable antenna.

5. The cable television apparatus in claim 1, wherein the directional coupler is configured to send the coupler signal to the compensation antenna; after the compensation antenna receives the coupler signal, the compensation antenna is configured to wirelessly send out the coupler signal to proceed the signal compensation.

6. The cable television apparatus in claim 1, wherein the cable television signal is radiated to generate the high frequency wireless cable television signal; the compensation antenna is configured to receive the high frequency wireless cable television signal; after the compensation antenna receives the high frequency wireless cable television signal, the compensation antenna is configured to send the high frequency wireless cable television signal to the directional coupler to proceed the signal compensation.

7. The cable television apparatus in claim 1 further comprising:
a choke, one side of the choke electrically connected to the input side and the input coaxial cable, the other side of the choke electrically connected to the output side and the output coaxial cable.

8. The cable television apparatus in claim 7 further comprising:
an input capacitor, one side of the input capacitor electrically connected to the input side, the input coaxial cable and one side of the choke, the other side of the input capacitor electrically connected to the coupler input side of the directional coupler; and
an output capacitor, one side of the output capacitor electrically connected to the output side, the output coaxial cable and the other side of the choke, the other side of the output capacitor electrically connected to the coupler output side of the directional coupler.

9. The cable television apparatus in claim 8 further comprising:
a transformer electrically connected to the coupler coupling side of the directional coupler.

10. The cable television apparatus in claim 9 further comprising:
a distribution circuit electrically connected to the transformer.
